(19) United States
(12) Patent Application Publication
(10) Pub. No.: US 2013/0059968 A1
(43) Pub. Date: Mar. 7, 2013

(54) PLASTIC COMPOSITION

(71) Applicants: Fei-Lin YANG, Taipei (TW); Yang-Po Chiu, Taipei (TW); Ching-Feng Chen, Taipei (TW); Po-Wen Huang, Taipei (TW); Chun-Kai Chou, Taipei (TW); Wun-Sheng Wu, Changhua County (TW); Win-Jon Lin, Teipei (TW); Ping-Huang Chen, Teipei (TW)

(72) Inventors: Fei-Lin YANG, Taipei (TW); Yang-Po Chiu, Taipei (TW); Ching-Feng Chen, Taipei (TW); Po-Wen Huang, Taipei (TW); Chun-Kai Chou, Taipei (TW); Wun-Sheng Wu, Changhua County (TW); Win-Jon Lin, Teipei (TW); Ping-Huang Chen, Teipei (TW)

(21) Appl. No.: 13/596,353

(22) Filed: Aug. 28, 2012

Related U.S. Application Data
(60) Provisional application No. 61/531,229, filed on Sep. 6, 2011.

(51) Int. Cl. C08L 67/02; C08K 3/04; C08K 3/40

(52) U.S. Cl. 524/538; 525/425

(57) ABSTRACT

The plastic composition includes PET and Nylon. The weight percentage of PET is between 20% and 90%. The weight percentage of Nylon is between 5% and 40%.

### CROSS REFERENCE TO RELATED APPLICATIONS

The non-provisional patent application claims priority to U.S. provisional patent application with Ser. No. 61/531,229 filed on Sep. 6, 2011. This and all other extrinsic materials discussed herein are incorporated by reference in their entirety.

### BACKGROUND OF THE INVENTION

1. Field of Invention

The present disclosure relates to a plastic composition.

2. Related Art

For energy saving and carbon reduction, more industries are starting the research of plastic material recycle and reproduction. The composition, PC/ABS, is a malleable plastic synthesized from PC (polycarbonate) and ABS (Acrylonitrile butadiene styrene). The PC/ABS composition composes the advantages of the polycarbonate and ABS, and is broadly used in car parts, office facilities, electronic communication equipments, home electrical appliances and lightings.

Usually, the PC/ABS composition is a reproduced recycled plastic composition made by collecting defective products from general manufacturing process of plastic products or recycled plastic materials from the discard discs, following with adding 10%-80% of general engineering plastics. However, the PC/ABS composition can not be added to more than 50% to meet the rigidity requirement of engineering plastic composition, which means less recycling amount and less environment protection. Besides, bisphenol A, an environmental hormone, may be produced during the recycle process, and it may remain on the plastic material and then threat human health.

### SUMMARY OF THE INVENTION

The present disclosure provides a plastic composition which can increase the recycled plastic amount and achieve environment protection purpose.

The composition of the plastic composition of the present disclosure includes PET (Polyethylene Terephthalate) and Nylon. Wherein, the weight percentage of PET is between 20% and 90% and the weight percentage of Nylon is between 5% and 40%.

As mentioned above, the main material of the plastic composition of the present disclosure is PET, which is broadly used in commercial products. For example, PET bottles are most commonly seen. Thus, this disclosure is to recycle and decompose huge amount of used PET bottles to retrieve PET, which is used as the main base (over 50%) of the plastic composition. In addition, 5%-40% of Nylon (available from abandoned Nylon) is added to increase the rigidity. The synthesized plastic composition can replace the present PC/ABS engineering plastic composition and further increase the effect of recycling and environment protection.

These and other features, aspects and advantages of the present invention will become better understood with regard to the following description, appended claims, and accompanying drawings.

### BRIEF DESCRIPTION OF THE DRAWINGS

FIG. 1 is a flow chart of a manufacturing method for a plastic composition according to a preferred embodiment of the present disclosure; and

FIG. 2 is a flow chart of another manufacturing method for the plastic composition according to the preferred embodiment of the present disclosure.

### DETAILED DESCRIPTION OF THE INVENTION

A plastic composition according to a preferred embodiment of the present disclosure comprises polyethylene terephthalate (PET) and Nylon. Wherein, the weight percentage of PET is between 20% and 90%, and the weight percentage of Nylon is between 5% and 40%. In this case, Nylon can be, for example, polycaprolactam (Nylon-6). PET and Nylon are both crystal materials.

In addition, in one embodiment, the plastic composition can further comprise polyphenylene sulfide (PPS). PPS can increase the rigidity of the plastic. The weight percentage of PPS, for example but not limited to, is greater then 0% and lower than 20%.

Besides, the plastic composition of the embodiment can further comprise a modifier. The modifier can include at least one of the solubilizer, lubricant, leveling agent, halogen-free flame retardant, toughener, curing agent and catalyst. The weight percentage of the modifier is, for example but not limited to, lower than 30%.

Furthermore, the plastic composition of the embodiment can further comprise glass fiber. The weight percentage of glass fiber is, for example but not limited to, lower than 20%. Additionally, the plastic composition of the embodiment can further comprise mineral fiber or carbon fiber. The mineral fiber can be, for example but not limited to, mica powder, talc powder, or any of other natural or artificial inorganic powders.

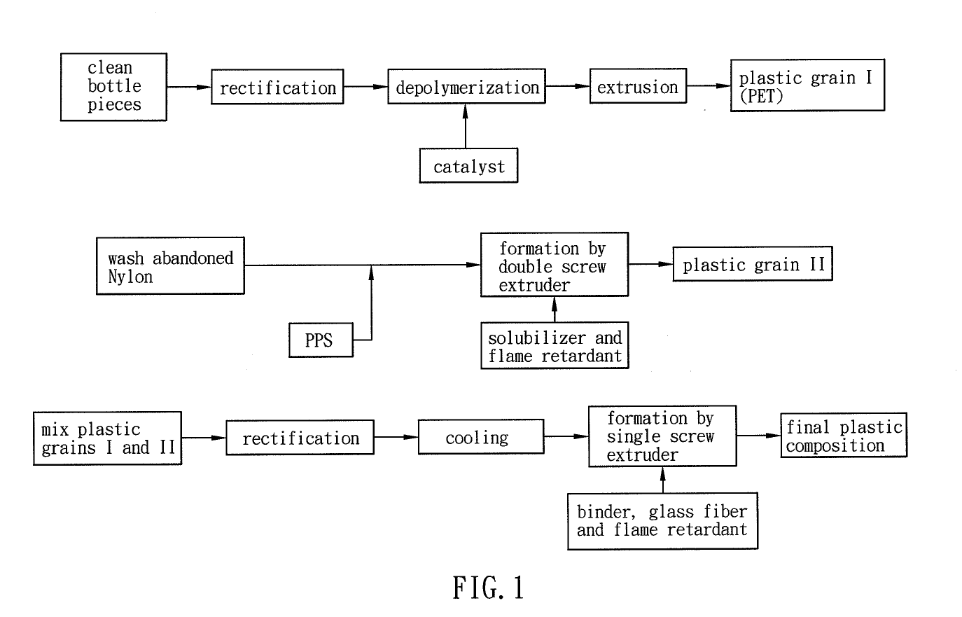

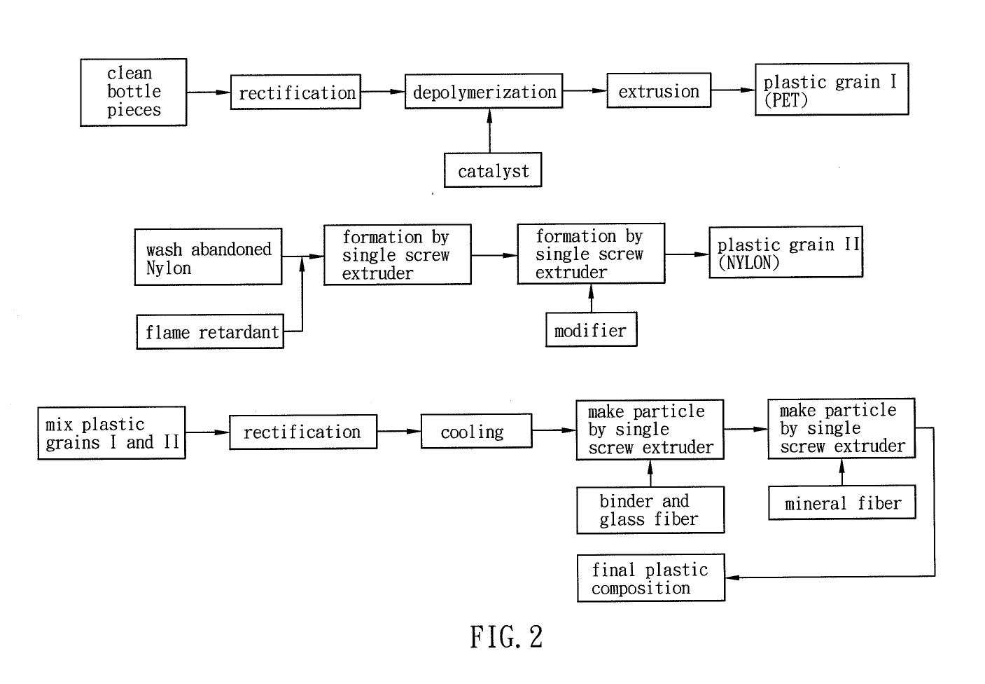

The plastic composition of the embodiment can be made by various kinds of methods. Examples are illustrated referring to FIG. 1 and FIG. 2.

The first method is shown as FIG. 1.

Firstly, the recycled used PET bottles are cut into pieces, which are then cleaned and moved into a reactor for rectification. A proper catalyst is added to depolymerize the plastic pieces to form the PET with higher molecular weight, which is cooled to obtain PET powder. Then, the PET powder is placed into the extruder so as to be melt and extruded. After separating the extruded product, the desired plastic grains I (the major component is PET) is thus obtained.

Secondly, the used Nylon is washed, dried and re-extruded to make particles. Herein, a double screw extruder is used. Moreover, PPS as well as solubilizer and flame retardant are added from different positions. The extruded product is then cut into plastic grains II, which are a composition containing Nylon and polyphenylene sulfide.

After mixing the plastic grains I and plastic grains II with a V-type mixer, and adding additives and lubricant during the mixing process, the composition is cleaned and then placed into the reactor for rectification. During the rectification reaction, the proper catalyst and curing agent are added to increase the viscosity. Then, the rectified composition is cooled to obtain powder product. The powder product as well as the proper binder, glass fiber and flame retardant are provided into the single screw extruder so as to manufacture the final extruded product. The extruded product is cooled down and cut to form the final plastic composition.

The second method is shown as FIG. 2.

Firstly, the recycled used PET bottles are cut into pieces, which are then cleaned and moved into a reactor for rectification. Then, the materials are placed into the reactor for depolymerization. During the reaction of depolymerization, the proper modifier and catalyst are added to depolymerize the plastic pieces to form the PET with higher molecular weight, which is cooled to obtain PET powder. Then, the PET powder is placed into the extruder to be melt and extruded. After separating the extruded product, the desired plastic grains I (the major component is PET) is thus obtained.

Secondly, the used Nylon is washed, dried and re-extruded to make particles. Herein, the modifier (including flame retardant) is added during a first extrusion. Afterward, the additional modifier is added during a second extrusion. Then, the extruded product is cut to obtain the desired plastic grains II (Nylon).

After mixing the plastic grains I and plastic grains II with a V-type mixer, adding lubricant during the mixing process, the composition is cleaned and then placed into the reactor for rectification. During the rectification reaction, the proper catalyst and curing agent are added to increase the viscosity. Then, the rectified composition is cooled to obtain powder product. The powder product as well as the proper binder and glass fiber are provided into the single screw extruder for a first extrusion. After cutting the extruded product and adding the proper mineral fiber or carbon fiber if needed, a second extrusion is performed to fabricate the final plastic composition.

In summary, the main material of the plastic composition of the present disclosure is PET, which is broadly used in commercial products. For example, PET bottles are most commonly seen. Thus, this disclosure is to recycle and decompose huge amount of used PET bottles to retrieve PET, which is used as the main base (over 50%) of the plastic composition. In addition, 5%-40% of Nylon (available from abandoned Nylon) is added to increase the rigidity. The synthesized plastic composition can replace the present PC/ABS engineering plastic composition and further increase the effect of recycling and environment protection. Moreover, PPS can also be added in the disclosure to increase the rigidity of the synthesized plastic composition.

The conventional method is to recycle the used bottles, collect the PET chip by addition or depolymerization, and then extrude to fabricate the plastic grains of the desired composite plastic composition by using a double screw extruder to mix PC and organic binder. However, the method of this disclosure uses Nylon as the mixing material. Because Nylon possesses great tenacity, it can provide most of the tenacity in the plastic composition.

The plastic composition of the present disclosure composes great rigidity and tenacity to meet the rigidity and tenacity demands of the external structure of the 3C products, such as laptop, cell phone, panel PC and etc. Thus, the plastic composition of this disclosure can be applied to 3C products. Besides, in this disclosure, the mineral fiber or carbon fiber can be added to further increase the rigidity.

The plastic composition made by the conventional manufacturing method can not meet the requirements of the engineering plastic materials for the 3C products if not used with halogen-free flame retardant. Thus, the conventional recycled plastic composition has not applied to the former mentioned products.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A plastic composition, comprising PET (Polyethylene Terephthalate) and Nylon, wherein the weight percentage of PET is between 20% and 90% and the weight percentage of Nylon is between 5% and 40%.

2. The plastic composition according to claim 1, wherein Nylon is polycaprolactam.

3. The plastic composition according to claim 1, further comprises polyphenylene sulfide (PPS).

4. The plastic composition according to claim 3, wherein the weight percentage of polyphenylene sulfide is lower than 20%.

5. The plastic composition according to claim 1, further comprises a modifier.

6. The plastic composition according to claim 5, wherein the weight percentage of the modifier is lower than 30%.

7. The plastic composition according to claim 5, wherein the modifier comprises at least one of solubilizer, lubricant, leveling agent, halogen-free flame retardant, toughener, curing agent, catalyst, binder, or their combinations.

8. The plastic composition according to claim 1, further comprises a glass fiber.

9. The plastic composition according to claim 8, wherein the weight percentage of the glass fiber is lower than 20%.

10. The plastic composition according to claim 1, further comprises a mineral fiber or carbon fiber.
